(19) United States
(12) Patent Application Publication
(10) Pub. No.: US 2008/0191546 A1
(43) Pub. Date: Aug. 14, 2008

(54) Automatic braking system for a motor vehicle

(76) Inventors: Louis Gino Plantamura, Peoria, IL (US); Michael A. Rabas, Bishop Hill, IL (US)

Correspondence Address: WENDEROTH, LIND & PONACK, L.L.P., 2033 K STREET N. W., SUITE 800, WASHINGTON, DC, 20006-1021, US

(21) Appl. No.: 11/705,403

(22) Filed: Feb. 13, 2007

(51) Int. Cl. B60T 7/12

(52) U.S. Cl. 303/28

(57) ABSTRACT

An automatic braking system for a motor vehicle includes a spring actuated parking brake, a service brake, a vehicle sensor, and a controller. When the service brake is in a switch applied actuated state, if it is determined that the energy source for the service brake is not sustainable, the controller controls the parking brake and the service brake so as to automatically actuate the parking brake and to automatically release the service brake from the actuated state. Also, when the vehicle is stopped, in order to ensure that only one brake is securing the vehicle, and in order to ensure that the brake securing the vehicle is the brake with the most sustainable energy source, whenever the parking brake is applied, even if the energy source could maintain the service brake in the actuated state, the service brake will be automatically released in order to confirm functionality of the parking brake and prevent the service brakes from masking a problem with the parking brake at a time when the driver may not be in the driver's seat and able to take remedial action.

### BACKGROUND OF THE INVENTION

1. Field of the Invention

The present invention relates to an automatic braking system for a motor vehicle. More particularly, the present invention relates to an automatic braking system for a motor vehicle, such as a utility vehicle or a construction vehicle, in which a switch applied service brake is automatically released and a parking brake is automatically applied on the basis of monitored operating conditions concerning the motor vehicle.

2. Related Art

Conventional braking systems for utility and construction vehicles employ a service brake, which can be actuated and released manually by an operator of the vehicle, and a parking brake, which can be actuated manually by the operator or actuated automatically based on certain detected conditions.

In a first example of such a conventional braking system, U.S. Pat. No. 6,729,696, which is incorporated herein by reference, discloses a braking system which utilizes a service brake and a parking brake. In this conventional braking system, when the vehicle is stopped and the parking brake is in an actuated state, the parking brake is prevented from being released until the operator of the vehicle applies the service brake. After the service brake is actuated, the operator can then manually release the parking brake.

In a second example of such a conventional braking system, U.S. Publication No. 2005/0029864, which is also incorporated herein by reference, discloses a braking system which utilizes a service brake and an emergency brake. In this conventional system, a monitoring device is provided for monitoring the condition of the vehicle. If the monitoring device detects an unacceptable operating state such as a defect in the service brake, then the monitoring device outputs a signal which causes the emergency brake to be automatically applied.

In such conventional braking systems, however, a problem can arise if the energy source for the service brake will soon become unavailable, and both of the service brake and the parking brake are in the actuated state. In such a situation, due to the continued switch applied application of the service brake, the energy source for the service brake continues to be depleted. Thus, if an unexpected and uncontrolled release of the parking brake was to occur, the vehicle would be susceptible to a roll away condition due to the depleted condition of the service brake energy source.

In view of the foregoing, what is needed is an automatic braking system that reduces the possibility of a vehicle roll away condition which can occur when more than one brake is able to secure the vehicle and an uncontrolled and unanticipated release of one of the brakes occurs at an inopportune time.

### SUMMARY OF THE INVENTION

It is a general objective of the present invention to provide a braking system which reduces the possibility of a vehicle roll away condition, and which ensures that the brake securing the vehicle is the brake which has the most sustainable energy source.

In an exemplary embodiment of the present invention, an automatic braking system is provided with a spring actuated parking brake, a service brake, a vehicle sensor, and a controller. According to the present invention, when the vehicle is stopped with the engine of the vehicle running, and the service brake is in a switch applied actuated state (i.e., when an operator of the vehicle actuated a switch causing the service brake to be applied), if it is determined based on information acquired by the vehicle sensor that the energy source for the service brake is not sustainable, the controller controls the parking brake and the service brake so as to automatically actuate the parking brake and to automatically release the service brake from the actuated state.

Further, when the vehicle is stopped and the engine of the vehicle is running, in order to ensure that only one brake is securing the vehicle at any given time, and in order to ensure that the brake securing the vehicle is the brake with the most sustainable energy source, whenever the spring actuated parking brake is applied, even if the energy source could maintain the service brake in the switch applied actuated state, the service brake will be automatically released.

By providing an automatic braking system with such a construction, the possibility of a vehicle roll away condition is reduced by eliminating the situation in which the energy source for a service brake is unnecessarily depleted to a level which would result in the service brake being unable to secure the vehicle, while also ensuring that the brake which is securing the vehicle is the brake which has the most sustainable energy source, and providing the ability to confirm the functionality of the parking brake.

The above and other features of the invention including various and novel details of construction and combination of parts will now be more fully described with reference to the accompanying drawings and pointed out in the claims. It will be understood that the particular features embodying the invention are shown by way of illustration only and not as a limitation of the invention. The principles and features of this invention may be employed in varied and numerous embodiments without departing from the scope of the invention.

### BRIEF DESCRIPTION OF THE DRAWINGS

Aspects of illustrative, non-limiting embodiments of the present invention will become more apparent by describing in detail embodiments thereof with reference to the attached drawings in which:

FIG. 1 depicts a block diagram showing an automatic braking system according to an embodiment of the present invention;

FIG. 2 depicts a circuit diagram of the automatic braking system according an exemplary embodiment of the present invention; and

FIG. 3 is a block diagram of an electronic controller according to an exemplary embodiment of the present invention.

### DETAIL DESCRIPTION OF THE INVENTION

The following description of the invention discloses specific configurations, features, and operations. However, the description is merely of an example of the present invention, and thus, the specific features described below are merely used to more easily describe the invention and to provide an overall understanding of the present invention.

Accordingly, one skilled in the art will readily recognize that the present invention is not limited to the specific embodiments described below. Furthermore, the description of various configurations, features, and operations of the present invention that are known to one skilled in the art are omitted for the sake of clarity and brevity. Also, it is to be understood that the phraseology and terminology employed herein is for the purpose of description and should not be regarded as limiting.

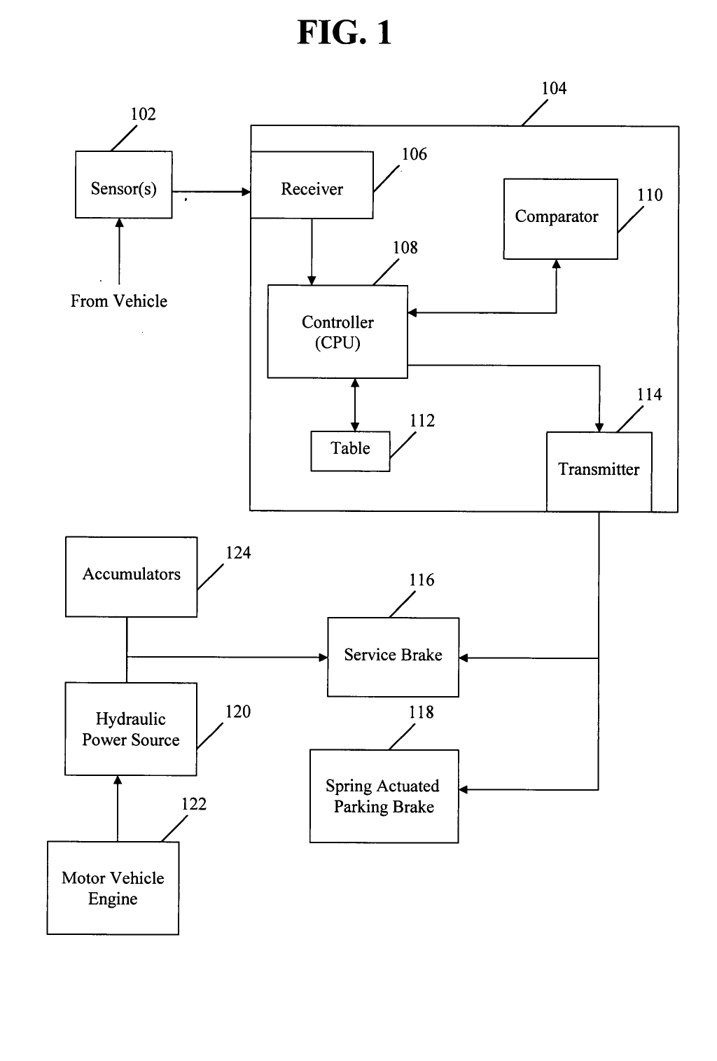

FIG. 1 is a block diagram of a braking system according to an illustrative embodiment of the present invention. In FIG. 1, a control unit 104 is provided for controlling a service brake 116 and a spring actuated parking brake 118, the control unit 104 being provided with a receiver 106, a controller (CPU) 108, a comparator 110, a memory table 112 and a transmitter 114. As shown in FIG. 1, the controller 108 is connected to each of the receiver 106, the comparator 110, the memory table 112, and the transmitter 114, and is responsible for controlling the overall operation of the control unit 104.

According to an exemplary embodiment of the invention, as shown in FIG. 1, the power source responsible for maintaining the service brake 116 in a switch applied actuated state is a hydraulic power source 120. As is known in the art, this hydraulic power can be provided by pumps which are driven mechanically by engine power provided by the motor vehicle engine 122. In the event that the hydraulic power source 120 should become unavailable, a backup source of hydraulic power, which is stored in a plurality of accumulators 124, can supply sufficient power to the service brake 116 to maintain the service brake in the switch applied actuated state for a limited period of time. In contrast to the service brake 116, the power source for maintaining the parking brake 118 in an actuated state is a spring whose power can be maintained indefinitely. As such, the parking brake 118 is considered to be a more sustainable brake than the service brake 116.

In FIG. 1, one or more sensors 102 are responsible for continuously monitoring various operating conditions concerning a vehicle, such as engine speed, vehicle speed, parking brake status (e.g., applied or released), service brake status (e.g., applied or released) and service brake pressure, and outputting the sensed data to the receiver 106. After receiving data from the sensors 102 representing various operating conditions of the vehicle, the receiver 106 transfers this data to the controller 108. The controller 108 is able to analyze the monitored data in order to determine the current operating conditions of the vehicle (e.g., vehicle is stopped, engine is running, service brake is actuated, parking brake is released, and service brake pressure is normal).

The table 112 can be accessed by the controller 108, if necessary, and is responsible for storing data that is used in determining if the hydraulic power source 120 is not sustainable. In particular, the table 112 is responsible for storing data such as a predetermined threshold, an acceptable operating range, and/or an acceptable operating state for one or more of the operating conditions being monitored by the sensors 102. The predetermined thresholds, ranges, and/or acceptable operating states stored in the table 112 represent normal operating conditions of the vehicle in which the hydraulic power source 120 is able to provide power to the service brake 116 for securing the vehicle in a stationary state.

In operation, when the vehicle is being monitored by the one or more sensors 102, after collecting data representing the operating conditions of the vehicle, the sensors 102 output such data to the receiver 106, and the receiver 106 transfers the received data to the controller 108. By analyzing the received data, the controller 108 is able to identify the current operating conditions of the vehicle (e.g., engine speed, vehicle speed, parking brake status, service brake status, brake pressure, etc.).

After identifying the current operating conditions of the vehicle, the controller 108 can access the table 112, if necessary, so as to obtain the corresponding thresholds, ranges, and/or acceptable operating states that are stored therein in advance. The data that is stored in the table 112 can be modified by a user as is known in the art, and therefore, the thresholds, ranges and acceptable operating states can be customized by a user for a particular vehicle.

After retrieving the corresponding data from the table 112, the controller 108, if necessary, can transfer the data received from the sensors 102, along with the corresponding data retrieved from the table 112, to the comparator 110 in order to make a determination as to whether the received data exceeds the predetermined threshold, falls outside of the predetermined range, or does not correspond to the predefined acceptable operating states.

In order to determine if the hydraulic power source 120 will become unavailable or is unsustainable, several different techniques may be utilized, such as (1) monitoring the motor vehicle engine 122 with a speed sensor or an engine oil pressure sensor, (2) monitoring the pressure in the pumps that drive the hydraulic power source 120 with a pressure sensor or a pressure switch, or (3) by monitoring the pressure in the accumulators 124 with either a pressure sensor or pressure switch. It should be recognized that these techniques for determining if the hydraulic power source 120 will become unavailable or is unsustainable are merely examples, and that other techniques utilizing other types of sensors can be utilized in connection with the present invention.

An example of a situation in which the hydraulic power source 120 for the service brake 116 will be determined as being unsustainable will be explained in connection with the following scenario. Assume that the motor vehicle engine 122 is running, and that the operator has stopped the vehicle by manually activating the service brake 116 via a service brake switch. In this condition, the service brake 116 is powered by the hydraulic power source 120 such that the service brake 116 is able to secure the vehicle in a stationary position.

While the service brake 116 is securing the vehicle, assume that the operator leaves the vehicle, and the engine unexpectedly stops causing an uncontrolled loss of power from the hydraulic power source 120. Upon such an occurrence, the hydraulic service brake 116 will still be able to secure the vehicle in a stationary position due to the energy supplied by the accumulators 124. However, because the energy stored in the accumulators 124 is not sustainable for a significant amount of time, once this energy has been depleted, the service brake will be unable to secure the vehicle, thereby leading to a hazardous situation which could easily result in a vehicle roll away condition.

Using the above-described sensors, such as an engine speed sensor or a brake pressure sensor, it is possible to detect the above-described hazardous situation in which the power source for the service brake will soon become unavailable. For example, such a condition can be detected through the use of the speed sensor upon detection of the engine speed going to zero, or through the use of the pressure sensor upon detection that the engine oil pressure has dropped below a predetermined threshold value.

Upon detecting this condition, the controller 108 outputs instructions which cause the parking brake, which is spring applied and therefore does not rely on the hydraulic power source 120 for actuation, to be automatically applied, and at the same time, causes the service brake 116 to be automatically released from the actuated state. By automatically applying the parking brake 118 in such a situation, the vehicle can be maintained in a secured position, and by automatically releasing the service brake 116 in such a situation, the energy source for the service brake 116 will not be unnecessarily depleted.

In addition, when the vehicle is stopped, in order to ensure that only one brake is servicing the vehicle at any given time, and in order to ensure that the brake servicing the vehicle is the brake with the most sustainable energy source, if the spring actuated parking brake 118 is manually applied by an operator, even if the hydraulic power source 120 could maintain the service brake 116 in the switch applied actuated state, the service brake 116 will be automatically released. Further, by automatically releasing the service brake 116 in this situation, it is possible to confirm functionality of the parking brake 118 and prevent the service brake 116 from masking a problem with the parking brake 118 at a time when the driver may not be located in the vehicle and able to take remedial action.

Moreover, as an additional feature of the present invention, a proximity sensor can be provided within the vehicle which is able to detect whether the operator of the vehicle is located in the driver's seat. The proximity sensor may be a pressure switch in the driver's seat, a limit switch in the driver's seat, an infrared sensor that is able to detect the presence of the operator in the driver's seat, or any other type of sensor that can be used to detect the presence of the operator in the driver's seat.

When the vehicle is stopped, and it is detected by the proximity sensor that the operator is not located in the driver's seat, the controller 108 operates so as to cause the parking 118 brake to be automatically applied and, at the same time, the service brake 116 to be automatically released, regardless of the sustainability of the service brake 116. By providing such a capability, if the vehicle has been stopped by the switch actuation of the service brake 116, and the engine is still running, if the operator exits from the vehicle, even if there is no indication that the power source for the service brake 116 will soon become unavailable, the controller 108 causes the parking brake 118 to be automatically applied and the service brake 116 to be automatically released, thereby providing an additional safety measure.

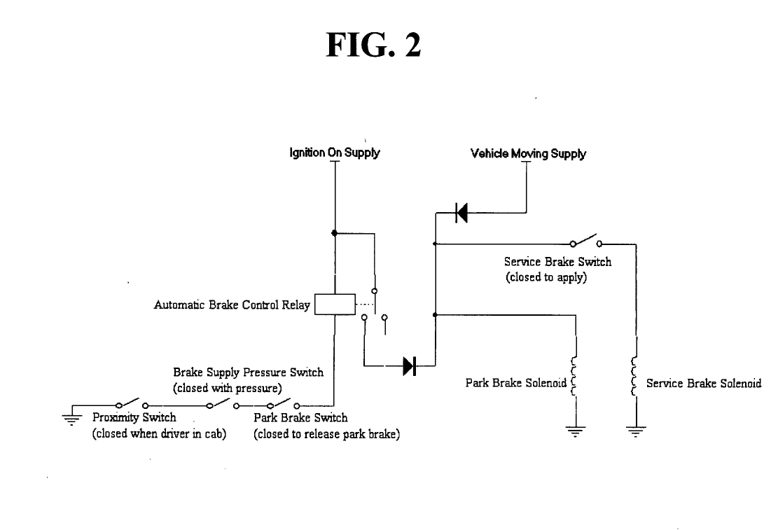

For example, assume that the operator of the vehicle has stopped the vehicle by the switch actuation of the service brake 116, and then proceeds to exit the vehicle without turning off the ignition (i.e., with the engine still running). At some point in time after the operator exits the vehicle, should the engine unexpectedly stop running, the service brake 116 will be automatically released due to the absence of power from an Ignition On power supply, as will be described below with reference to FIG. 2, and the parking brake 118 will be automatically applied. However, in the event that the parking brake 118 fails (e.g., fails to actuate) and is thus not able to secure the vehicle, because the operator is not in the vehicle, and therefore cannot manually actuate the service brake 116, the vehicle would be susceptible to a potentially hazardous roll away condition.

Accordingly, in order to prevent such an occurrence, by providing the above-described proximity sensor that is able to detect the presence of the operator in the driver's seat, if the vehicle is stopped, upon a determination that the operator is not located in the driver's seat, the controller will cause an immediate release of the switch actuated service brake 116 and actuation of the parking brake 118. By releasing the service brake 116 and applying the parking brake 118 as soon as the operator of the vehicle leaves the driver's seat, if there is a malfunction of the parking brake (e.g., the parking brake does not apply), the driver should have sufficient time to re-enter the vehicle and apply the switch actuated service brake 116 before a roll away condition occurs.

FIG. 2 depicts a circuit diagram of the automatic braking system according to an exemplary embodiment of the present invention. As shown in FIG. 2, the automatic braking system includes a brake supply pressure switch, a park brake switch, a service brake switch, a proximity switch, and an automatic brake control relay. The automatic brake control relay will remain energized, thus providing the necessary power to maintain the service brake in the actuated state and the parking brake in the released state, as long as the Ignition On power supply is energized and the brake supply pressure switch, park brake switch and the proximity switch are closed.

In particular, referring to FIG. 2, the automatic brake control relay will be energized if (1) the ignition of the vehicle is on, (2) the brake supply pressure is above the threshold of the brake supply pressure switch which will cause the brake supply pressure switch to be closed, (3) the parking brake switch is in the closed position (i.e., the parking brake release position), and (4) the proximity sensor detects the presence of a driver in the vehicle.

If all of these conditions are met, then the power from the Ignition On power supply will be on the normally open contact of the automatic brake control relay which is connected to the park brake solenoid and the service brake switch. In this case, the park brake solenoid will be energized which will release the parking brake and provide power to the service brake switch so that if the service brake switch is actuated, it will be able to power the service brake solenoid so as to apply the service brake.

On the other hand, if at least one of the above-noted conditions is not met (e.g., the vehicle ignition is off), then the automatic brake control relay will not energize the park brake solenoid or provide power to the service brake switch. In this case, the parking brake will apply immediately unless the vehicle is moving in which case the parking brake will be held off by the Vehicle Moving Supply, but will apply automatically when the vehicle stops. Also, when at least one of the above-noted conditions is not met (e.g., the vehicle ignition is off), it will not be possible to apply the service brake using the service brake switch unless the vehicle is moving (e.g., during an emergency stop condition) in which case it will always be possible to apply the service brake by actuating the service brake switch which will be energized by the Vehicle Moving Supply. In such a situation, the service brake 116 will then release automatically when the vehicle has stopped and the parking brake 118 will be automatically applied.

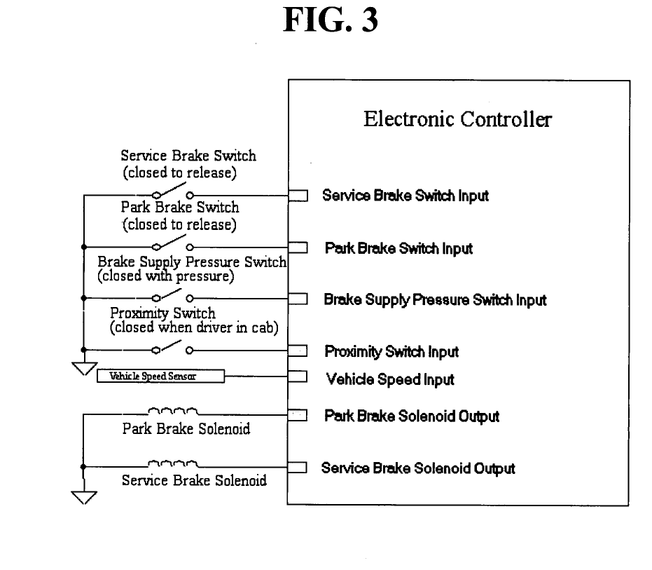

FIG. 3 depicts an electronic controller which can be utilized in an exemplary embodiment of the present invention. As shown in FIG. 3, the electronic controller is coupled to a service brake switch, a park brake switch, a brake supply pressure switch, a proximity switch, a vehicle speed sensor, a park brake solenoid, and a service brake solenoid. The logic for the Electronic Controller is as follows:

```
if (vehicle speed = 0) then
  if (Brake Supply Pressure Switch Input = 0 AND Proximity Switch
  Input = 0)
then ; 0 = switch closed, 1 = switch opened
    if (Service Brake Switch Input = 0 AND Park Brake Switch
    Input = 0) then
      Park Brake Solenoid Output = HI; HI = parking brake released
      Service Brake Solenoid Output = LO; LO = service brakes released
    elseif (Service Brake Input = 0 AND Park Brake Switch Input = 1)
    then
      Park Brake Solenoid Output = LO; LO = parking brake applied
      Service Brake Solenoid Output = LO; LO = service brakes released
    elseif (Service Brake Input = 1 AND Park Brake Switch Input = 0)
    then
      Park Brake Solenoid Output = HI; HI = parking brake released
      Service Brake Solenoid Output = HI; HI = service brakes applied
    else (Service Brake Input = 1 AND Park Brake Switch Input = 1)
    then
      Park Brake Solenoid Output = LO; LO = parking brake applied
      Service Brake Solenoid Output = LO; LO = service brakes released
    endif
  else
    Park Brake Solenoid Output = LO; LO = parking brake applied
    Service Brake Solenoid Output = LO; LO = service brakes released
  endif
else
  Park Brake Solenoid Output = HI; HI = parking brake released
  if (Service Brake Switch Input = 0)then
    Service Brake Solenoid Output = LO; LO = service brakes released
  else
    Service Brake Solenoid Output = HI; HI = service brakes applied
  endif
endif.
```

By providing an automatic braking system with the above construction, the possibility of a vehicle roll away condition is reduced by eliminating the situation in which the energy source for a service brake is unnecessarily depleted to a level which would result in the service brakes in the switch actuated state being unable to secure the vehicle, while also ensuring that the brake which is securing the vehicle is the brake which has the most sustainable energy source, and providing the ability to confirm the functionality of the parking brake.

The previous description of embodiments is provided to enable a person skilled in the art to make and use the present invention. Moreover, various modifications to the illustrative embodiments above will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

What is claimed is:

1. An automatic braking system for a vehicle, the automatic braking system comprising:
a parking brake which can be actuated automatically or by an operator of the vehicle;
a service brake which can be actuated by the operator of the vehicle and which can be released automatically;
a monitoring device operable to monitor at least one of a plurality of operating conditions concerning the vehicle; and
a controller operable to control the parking brake and the service brake on a basis of the at least one monitored operating condition of the plurality of operating conditions concerning the vehicle so as to cause the parking brake to be automatically actuated and the service brake to be automatically released from an actuated state.

2. The automatic braking system according to claim 1,
wherein the controller controls the parking brake to be automatically actuated and the service brake to be automatically released from the actuated state when it is determined that (1) the vehicle is not moving, (2) the service brake is in the actuated state, (3) the parking brake is in a released state, and (4) the engine of the vehicle switches from an on state to an off state.

3. The automatic braking system according to claim 1,
wherein the controller controls the parking brake to be automatically actuated and the service brake to be automatically released from the actuated state when it is determined that (1) the vehicle is not moving, (2) the service brake is in the actuated state, (3) the parking brake is in a released state, and (4) a brake supply pressure for the service brake is below a predetermined threshold.

4. The automatic braking system according to claim 1,
wherein the controller controls the parking brake to be automatically actuated and the service brake to be automatically released from the actuated state when it is determined that (1) the vehicle is not moving, (2) the service brake is in the actuated state, (3) the parking brake is in a released state, and (4) the operator of the vehicle is not located in a driver's seat of the vehicle.

5. The automatic braking system according to claim 1, wherein the actuated state of the service brake is a switch applied actuated state.

6. A control system for controlling a braking system of a vehicle, the braking system including a parking brake which can be actuated automatically or by an operator of the vehicle, and a service brake which can be actuated by the operator of the vehicle and which can be released automatically, said control system comprising:
a controller operable to receive at least one monitored operating condition concerning the vehicle from a vehicle monitoring device, and to control the parking brake and the service brake on a basis of the at least one monitored operating condition received from the vehicle monitoring device,
wherein the controller is operable to control the parking brake and the service brake on the basis of the at least one monitored operating condition so as to cause the parking brake to be automatically actuated and the service brake to be automatically released from an actuated state.

7. The control system according to claim 6,
wherein the controller controls the parking brake to be automatically actuated and the service brake to be automatically released from the actuated state when it is determined that (1) the vehicle is not moving, (2) the service brake is in the actuated state, (3) the parking brake is in a released state, and (4) the engine of the vehicle switches from an on state to an off state.

8. The control system according to claim 6,
wherein the controller controls the parking brake to be automatically actuated and the service brake to be automatically released from the actuated state when it is determined that (1) the vehicle is not moving, (2) the service brake is in the actuated state, (3) the parking brake is in a released state, and (4) a brake supply pressure for the service brake is below a predetermined threshold.

9. The control system according to claim 6,
wherein the controller controls the parking brake to be automatically actuated and the service brake to be automatically released from the actuated state when it is determined that (1) the vehicle is not moving, (2) the service brake is in the actuated state, (3) the parking brake is in a released state, and (4) the operator of the vehicle is not located in a driver's seat of the vehicle.

10. The control system according to claim 6, wherein the actuated state of the service brake is a switch applied actuated state.

11. An automatic braking system for a vehicle, the automatic braking system comprising:
a parking brake which can be actuated by an operator of the vehicle;
a service brake which can be actuated by the operator of the vehicle and which can be released automatically;
a monitoring device operable to monitor at least one of a plurality of operating conditions concerning the vehicle; and
a controller operable to control the service brake on a basis of the at least one of the plurality of monitored operating conditions so as to cause the service brake to be automatically released from an actuated state upon a determination that the parking brake has been actuated by the operator of the vehicle.

12. The automatic braking system according to claim 11,
wherein the controller controls the service brake so as to cause the service brake to be automatically released from the actuated state upon a determination that the parking brake has been actuated by the operator of the vehicle only if the vehicle is not moving.

13. A control system for controlling a braking system of a vehicle, the braking system including a parking brake which can be actuated automatically or by an operator of the vehicle, and a service brake which can be actuated by the operator of the vehicle and which can be released automatically, said control system comprising:
a controller operable to receive at least one monitored operating condition of a vehicle from a vehicle monitoring device, and to control the service brake on a basis of the at least one monitored operating condition received from the vehicle monitoring device,
wherein the controller is operable to control the service brake on the basis of the at least one monitored operating condition so as to cause the service brake to be automatically released from an actuated state upon a determination that the parking brake has been actuated by the operator of the vehicle.

14. The control system according to claim 13,
wherein the controller controls the service brake so as to cause the service brake to be automatically released from the actuated state upon a determination that the parking brake has been actuated by the operator of the vehicle only if the vehicle is not moving.
